(19) United States
(12) Patent Application Publication
(10) Pub. No.: US 2006/0103114 A1
(43) Pub. Date: May 18, 2006

(54) Structure for swiveling and anchoring the front wheel of a tricycle

(75) Inventor: Pao-Shan Huang, Chia-I Hsien (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 10/986,220

(22) Filed: Nov. 12, 2004

(51) Int. Cl. B62B 7/00

(52) U.S. Cl. 280/642

(57) ABSTRACT

A structure for swiveling and anchoring the front wheel of a tricycle includes an actuation assembly, which has a rotary knob located above an anchor dock to turn a driving disk that has sloped surfaces to move an anchor pin upwards to control release and latching of a wheel seat so that the front wheel of the tricycle may be swiveled freely or moved forwards in a constant direction. As the rotary knob is located above the driving disk, the latch condition of the tricycle frame is less likely to be released by incidental impact. Therefore improved safety may be achieved.

### FIELD OF THE INVENTION

The invention relates to a structure for swiveling and anchoring the front wheel of a tricycle, and particularly to a structure adopted for use on a three-wheel stroller to control swiveling of the front wheel.

### BACKGROUND OF THE INVENTION

Strollers mainly include a frame and a plurality of wheels coupled pivotally on the bottom of the frame. The frame is covered by a pliable fabric for seating a baby and is coupled with a handlebar for parents to grasp and move the stroller. A wide variety of strollers are now available on the market. In terms of the frame, some are collapsible, and some are not collapsible. Some have one seat, while some have two seats. Some provide general functions, while some are for exercise purposes. And some have three wheels, while some have four wheels. Strollers for exercise (reference can be found in U.S. Pat. Nos. 6,196,572, 5,876,309 and 5,536,033) are mainly to seat and move the baby on the stroller while the parent is jogging. To improve maneuverability, the stroller for exercise usually adopts a three-wheel design. Namely, there is one front wheel and two rear wheels. Such a structure allows the stroller to be moved faster while the user is doing exercise (namely jogging). To prevent the stroller from toppling due to undesirable road conditions or inadvertent handling of the user, the front wheel and the rear wheels have to be moved forwards without changing direction to ensure the safety of the baby sitting on the stroller.

U.S. Pat. No. 6,671,926 discloses an anchor structure for the rotary front wheel of a three-wheel stroller that is installed on the front side of the front rack. However, because its latch mechanism is located on the front side of the font rack, the latch mechanism tends to be released when the stroller hits bumps in the road, causing the front wheel to turn or anchor improperly and resulting in dangerous situations.

### SUMMARY OF THE INVENTION

In view of the problems of the conventional stroller with a latch mechanism installed on the front end of the frame, which can be released upon impact and result in dangerous situations, the primary object of the invention is to provide an actuation assembly located above an anchor dock that has a turnable sloped surface to drive and control release and latching of an anchor pin and a wheel seat so that the front wheel may be swiveled as desired and anchored for moving forwards in a constant direction. A rotary knob is located above a driving disk to form a secure latch without releasing the frame caused by incidental impact to achieve improved safety.

The foregoing, as well as additional objects, features and advantages of the invention will be more readily apparent from the following detailed description, which proceeds with reference to the accompanying drawings. The descriptions and drawings are for illustrative purposes only, and are not limitative of the invention.

### BRIEF DESCRIPTION OF THE DRAWINGS

FIG. 1 is a side view of the invention.

FIG. 2 is an exploded view of the invention.

FIG. 3 is a perspective view of the invention.

FIG. 4 is a schematic side view of the invention in an operating condition.

### DESCRIPTION OF THE PREFERRED EMBODIMENT

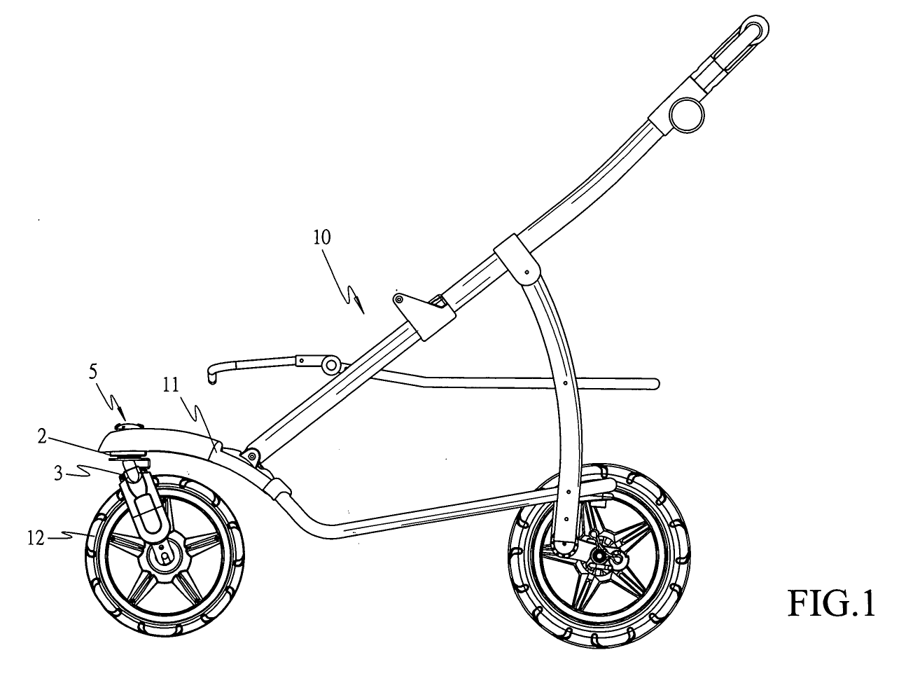

Referring to FIG. 1, the structure for swiveling and anchoring the front wheel of a tricycle according to the invention is installed on a front wheel rack 11 of a frame 10 of a three-wheel stroller to control swiveling and anchoring of a front wheel 12. The anchor structure includes an anchor dock 2 and a wheel seat 3.

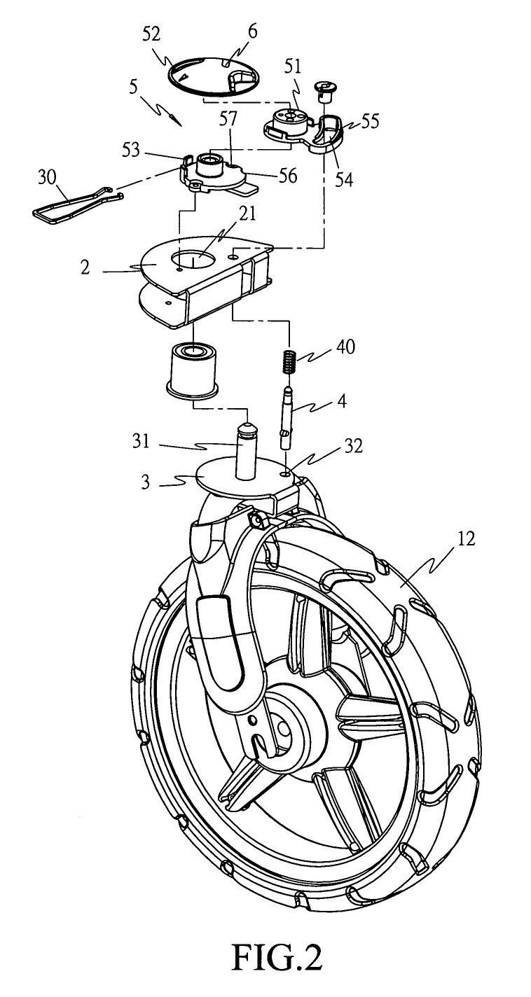

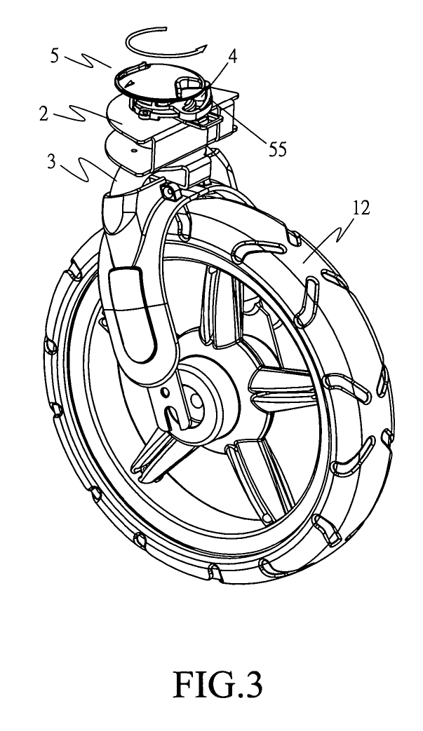

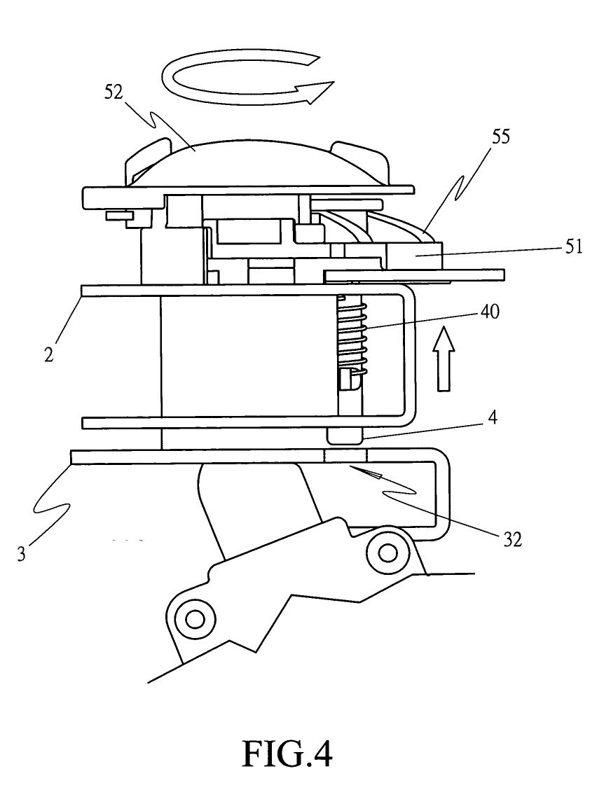

Referring to FIGS. 2, 3 and 4, the anchor dock 2 is coupled on the front end of the front wheel rack 11, and has a pivot hole 21. The wheel seat 3 is coupled with the front wheel 12 and has a center shaft 31 running through the pivot hole 21 so that the wheel seat 3 may be swiveled about the center shaft 31. In an embodiment of the invention, the wheel seat 3 may be selectively coupled with the anchor dock 2 or detached through an elastic clip 30. The wheel seat 3 has an anchor section 32 that is an aperture in this embodiment to receive an anchor pin 4 and form an anchor condition.

The anchor pin 4 is mounted onto the anchor dock 2 and is movable thereon. The anchor pin 4 has a lower end to form a latch condition with the anchor section 32 of the wheel seat 3 to inhibit the wheel seat 3 from turning. In this embodiment, the anchor pin 4 maintains the latch condition with the wheel seat 3 through a spring 40.

There is an actuation assembly 5 to control the movement of the anchor pin 4 to put the wheel seat 3 in an anchor condition or a turnable condition. The actuation assembly includes a driving disk 51, a rotary knob 52 and an anchor plate 53. The driving disk 51 is pivotally coupled on the center shaft 31 and has a slot 54 to allow the anchor pin 4 to pass through. The slot 54 has two sides forming sloped surfaces 55 to create a sliding contact with other end of the anchor pin 4. When the driving disk 51 is turned, the anchor pin 4 is gradually pushed upwards by the sloped surfaces 55 so that one end of the anchor pin 4 escapes the anchor section 32 of the wheel seat 3. Thus the wheel seat 3 is free from the harness of the anchor pin 4 and may be turned as desired.

The anchor plate 53 is located on the anchor seat 2 and has a first latch section 56 and a second latch section 57. The rotary knob 52 is located on the actuation disk 51 for users to drive and rotate the actuation disk 51. The rotary knob 52 further has a boss 6 corresponding to the first latch section 56 and the second latch section 57 to provide latching of the anchor pin 4 while in anchor and release conditions.

Therefore, users can directly turn the rotary knob 52 to rotate the rotary disk 51, which in turn moves the anchor pin 4 up or down through the sloped surfaces 55 to free the wheel seat 3 for turning or anchoring the wheel seat 3 without swiveling.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A structure for swiveling and anchoring a front wheel of a tricycle, installed on a distal end of a front leg bracket of the tricycle to control latching and swiveling of a front wheel assembly, comprising:
a wheel seat, having a center shaft pivotally coupled on a lower side of a front leg rack for turning and an anchor section;
an anchor dock, fixedly mounted onto the distal end of the front leg bracket to receive the center shaft for anchoring;
an anchor pin, running through the anchor dock and being movable up and down and having a lower end latchable on the anchor section of the wheel seat to form an anchor condition; and
an actuation assembly, pivotally coupled on the anchor dock turnable to move a sloped surface which keeps a sliding contact with the anchor pin so that the anchor pin is moved downwards to insert into the anchor section to form a latch condition, or moved upwards to escape the anchor section and release the latch condition to allow the wheel seat to swivel freely.

2. The structure of claim 1, wherein the anchor section of the wheel seat is an aperture.

3. The structure of claim 1, wherein the anchor pin maintains the latch condition with anchor section of the wheel seat through a spring.

4. The structure of claim 1, wherein the actuation assembly includes a rotary knob, a driving disk and an anchor plate, the anchor plate being fastened to the anchor dock and having a first latch section and a second latch section.

5. The structure of claim 4, wherein the rotary knob is located above the driving disk to rotate the driving disk, and has a boss to latch on the first latch section and the second latch section.

6. The structure of claim 4, wherein the driving disk includes a slot to allow other end of the anchor pin to pass through and move within the range of the slot.

7. The structure of claim 6, wherein the driving disk has sloped surfaces on the periphery of the slot to be in contact with the other end of the anchor pin such that the anchor pin is pushed upwards by the sloped surfaces when the driving disk rotates.
